(19) United States
(12) Patent Application Publication
(10) Pub. No.: US 2012/0140460 A1
(43) Pub. Date: Jun. 7, 2012

(54) LED LAMP

(75) Inventor: KUO-CHENG CHANG, Chu-Nan, Miao-Li (TW)

(73) Assignee: FOXSEMICON INTEGRATED TECHNOLOGY, INC., Chu-Nan (TW)

(21) Appl. No.: 13/292,100

(22) Filed: Nov. 9, 2011

(30) Foreign Application Priority Data
Dec. 6, 2010 (TW) 099142472

(51) Int. Cl. F21S 4/00

(52) U.S. Cl. 362/219

(57) ABSTRACT

An LED lamp includes a tubular first envelope, a cover arranged at an end of the first envelope, a power box arranged at an opposite end of the first envelope, and a tubular second envelope having a color different from that the first envelope. The second envelope is slideably mounted on the first envelope. A plurality of electrical microswitches is arranged peripherally on the power box. When all of the microswitches are inside relief cavities in the second envelope, the LED lamp turns on and light generated by the LED lamp radiates first through the first envelope and then the second envelope to a surrounding environment. When at least one of the microswitches is compressed by the second envelope, the LED lamp turns off.

### BACKGROUND

1. Technical Field

The disclosure relates to an LED (light emitting diode) lamp, and particularly to an LED lamp whose color is changeable.

2. Description of the Related Art

Light emitting diodes' (LEDs) many advantages, such as high luminosity, low operational voltage, low power consumption, compatibility with integrated circuits, easy driving, long term reliability, and environmental friendliness have promoted their wide use as a light source. Now, light emitting diodes are commonly applied in environmental lighting. However, a common LED lamp includes an LED module, and an envelope covering the LED module. Therefore, the common LED lamp has only one color temperature. The color temperature of the common LED lamp can not be changed.

Therefore, it is desirable to provide an LED lamp which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the present LED lamp. Moreover, in the drawings, like reference numerals designate corresponding parts throughout the views.

FIG. 1 is a schematic view of an LED lamp in accordance with a first embodiment.

FIG. 2 is an exploded view of the LED lamp of FIG. 1.

FIG. 3 is an exploded view of the LED lamp of FIG. 1 from another viewing angle.

FIG. 4 is a view similar to FIG. 1, but with the LED lamp being extended.

FIG. 5 is a cross-sectional view taken along line V-V of the LED lamp of FIG. 4.

### DETAILED DESCRIPTION

Embodiments of an LED lamp as disclosed are described in detail here with reference to the drawings.

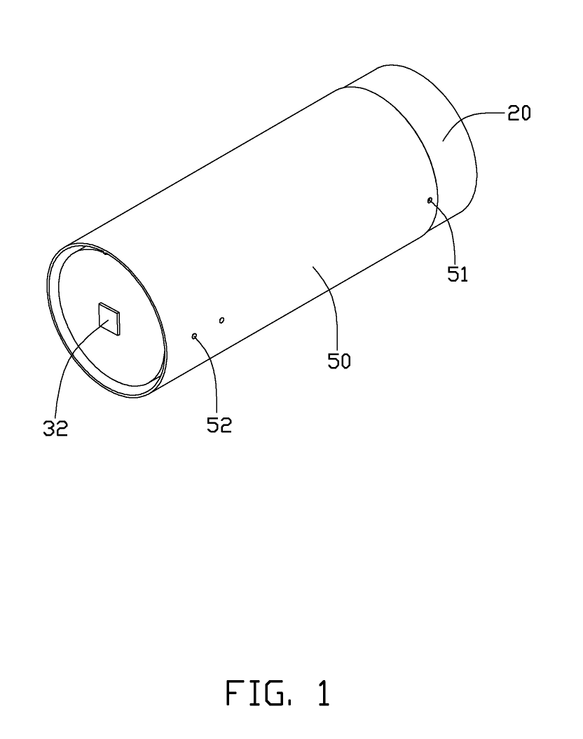

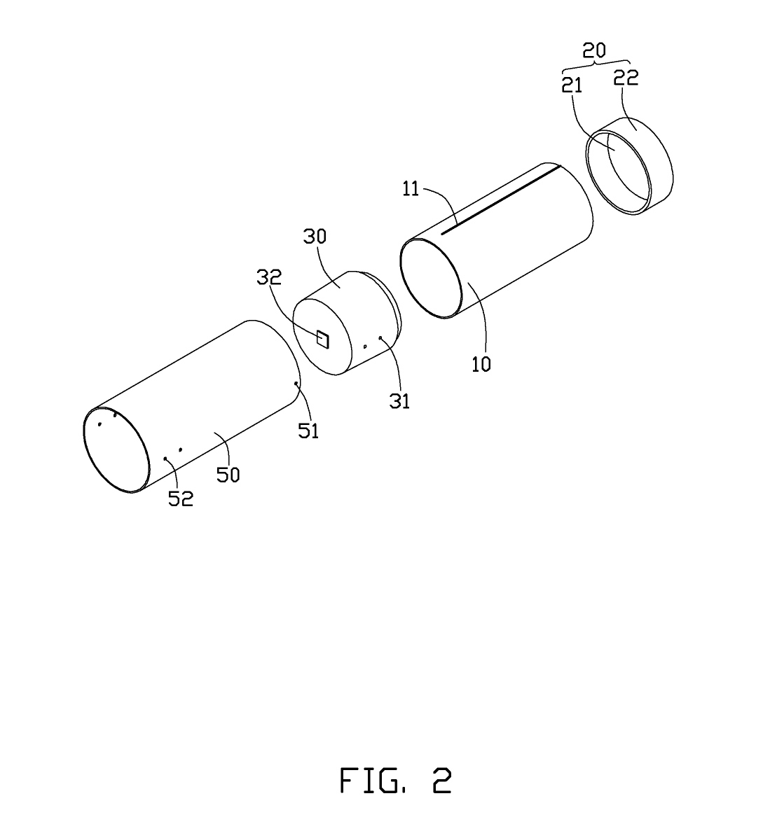

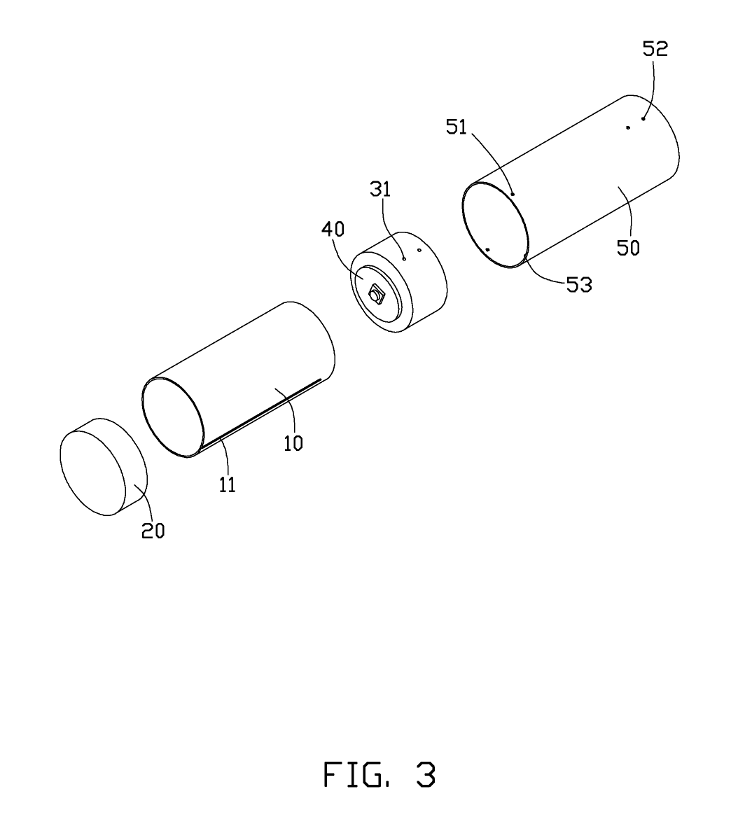

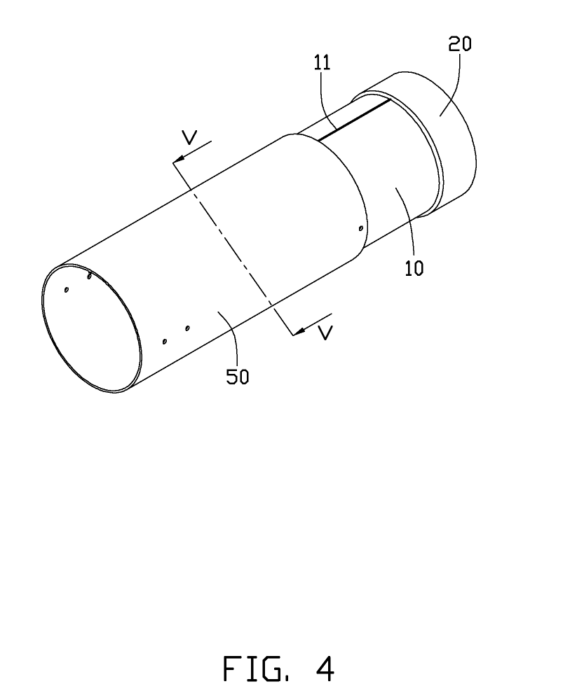

Referring to FIGS. 1-4, an LED lamp includes a first envelope 10, a cover 20 arranged at one end of the first envelope 10, a power box 30 arranged on the first envelope 10, an LED module 40, and a second envelope 50. The color translucency of the first envelope 10 is different from that of the second envelope 50.

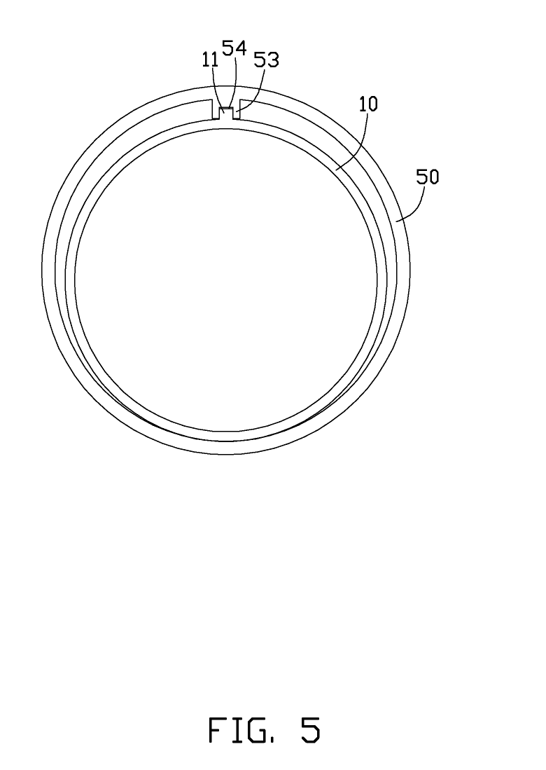

The first cover 10 is elongate and tubular. A first protruding strip 11 extends from the periphery of the first envelope 10 along a lengthwise direction of the first envelope 10. Referring to FIG. 5, the cross section of the first protruding strip 11 is rectangular.

In this embodiment, the quantity of the first protruding strip 11 is one. In another embodiment, the quantity of the first protruding strip 11 can be more than one. A plurality of the first protruding strips 11 may be distributed uniformly around the periphery of the first envelope 10.

In this embodiment, an end of the first protruding strip 11 is coplanar with the end face of the first envelope 10 near the cover 20. A certain distance remains between the other end of the first protruding strip 11 and one end of the first envelope near the power box 30. This certain distance provides an open area for the installation of the power box 30 on the first envelope 10.

The cover 20 is a tubular structure having one end closed. The cover 20 includes a plate 21 and a tubular wall 22 extending from the plate 21. The tubular wall 22 of the cover 20 encapsulates one end of the first envelope 10. In this embodiment, the tubular wall 22 has a groove (not shown). When the cover 20 encapsulates the first envelope 10, the first protruding strip 11 of the first envelope 10 is inserted into the groove of the tubular wall 22, to prevent rotation and to assist in securing the cover 20 to the first envelope 10. The inside surface of the tubular wall 22 is in contact with the outside surface of the first envelope 10.

The power box 30 is a tubular structure. A plurality of electrical microswitches 31, standing protruding of the surface of the power box 30, is arranged around the periphery of the power box 30. In this embodiment, the quantity of the microswitches 31 is four. Each pair of microswitches 31, being a group, are diametrically opposite. A switch 32 is arranged on the bottom of the power box 30. The LED module 40 is arranged on the top of the power box 30.

The power module (not shown) arranged inside the power box 30 provides electrical energy to the LED module 40. The power box 30 containing the LED module 40 is threaded onto one end of the first envelope 10, and thus the LED module 40 is arranged inside the first envelope 10.

The second envelope 50 is tubular and elongated. Two second through holes 51 are arranged on the top of the second envelope 50. Four first through holes 52 are arranged on the bottom of the second envelope 50. The two second through holes 51 are arranged at opposite sides of the second envelope 50. The four first through holes 52 are in two pairs, each pair being arranged on opposite sides of the second envelope 50. Each pair of first through holes 52 is diametrically opposite, and each of the second through holes 51 is aligned with two of the first through holes 52 at the same side.

Referring to FIG. 5, a second protruding strip 53 extends inwards from the inside surface of the second envelope 50. The second protruding strip 53 also extends along a lengthwise direction of the second envelope 50. A cross section of the second protruding strip 53 is concave in shape. A slot 54 is defined on the outside of the second protruding strip 53. The slot 54 is a guide in which the first protruding strip 11 of the first envelope 10 can slide. In this embodiment, the slide is formed in the internal surface of the second protruding strip 53.

During the installation process of the LED lamp, the cover 20 and the power box 30 are secured at opposite ends of the first envelope 10. The LED module 40 is arranged inside the first envelope 10. The cover 20, the power box 30, the first envelope 10, and the LED module 40 constitute a first LED lamp portion.

Until pressure is applied to all of the microswitches 31, all of the microswitchess 31 are uncompressed. When all microswitches 31 of the power box 30 are uncompressed, the power module of the power box 30 provides electrical energy to the LED module 40. Thus, the first LED lamp portion is on.

The switch 32 is a push-on push-off toggle switch; thus when a user presses the switch 32 of the power box 30 to close the switch circuit, the power module stops providing electrical energy to the LED module 40. Thus, the first LED lamp portion is turned off

When user presses the switch 32 again, the power module provides electrical energy to the LED module 40. Thus, the first LED lamp portion works again.

When the perceived color of light being emitted by the first LED lamp portion is to be changed, the second envelope 50 is arranged on the outside of the first LED lamp portion to complete the LED lamp of the disclosure.

The second envelope 50 is mounted to the power box 30 at a position where a bottom pair of the microswitches 31 is in the second through holes 51. Then, the top portion of the second envelope 50 is pushed to the tubular wall 22 of the cover 20 during which the second protruding strip 53 slides over the first protruding strip 11.

During the movement of the second envelope 50, all of the microswitches 31 of the power box 30 are first compressed, and then, all of the microswitches 31 of the power box 30 protrude into the first through holes 52 of the second envelope 50, allowing all of the microswitches 31 to be released from compression.

When the all of the microswitches 31 are uncompressed, the LED module 40 is on. Light from the LED module 40 also passes through the second envelope 50, in addition to the first envelope 10. Because the color of the second envelope 50 in translucency is different from that of the first envelope 10, the color of light passing through the first and second envelopes 10, 50 is different from that passing the first envelope 10 only. In this embodiment, the light emitted from the first and second envelopes 10, 50 appears yellow, and from the first envelope 10 only appears white. The LED module 40 emits whit light. The first envelope 10 is transparent while the second envelope 50 is yellow and translucent.

In this embodiment, when all of the microswitches 31 of the power box 30 have been released and the switch 32 of the power box 30 is in an off status, the power module provides electrical energy to the LED module 40. When one of the microswitches 31 of the power box 30 is compressed and the switch 32 of the power box 30 is in an off status, the power module does not provide any electrical energy to the LED module 40.

The status of the microswitches 31 of the power box 30 is irrelevant if the switch 32 of the power box 30 is in an on status. In that situation, the power module does not provide electrical energy to the LED module 40. The switch 32 of the power box 30 functions as a master switch controlling the on or off status of the LED lamp.

In brief, the user may change the color output of light of the LED lamp by mounting the second envelope 50 to the first envelope 10 and then moving the second envelope 50 to cover the first envelope 10.

During the operating process of the LED lamp, many different translucency colors of the second envelope 50 may be provided according to specific needs. Thus, the user can change between many different colors of light output by the LED lamp. Moreover, the optical field may be changed by applying different shapes to the first envelope 10 and the second envelope 50. The intensity of light from the LED lamp can be changed by different qualities of translucence in the first envelope 10 and the second envelope 50.

Moreover, a timer may be arranged inside the power box 30 to increase the functionality of the LED lamp.

In another embodiment, the master switch function of the switch 32 may be achieved by other means, for example by the user turning on or turning off the LED lamp by pushing and pulling or by simply rotating the second envelope 50.

The turning on or turning off of the LED lamp may be achieved by pulling the second envelop 50 away the cover 20. Thus, at least one microswitch 31 of the power box 30 is compressed by the second envelope 50, and the LED lamp turns off. The LED lamp may be switched on by pushing the second envelope 50 towards the cover 20 until the all of the microswitches 31 of the power box 30 are within the second envelope 50 and in an uncompressed status, thus the LED lamp turns on.

In another method, the user may turn off the LED lamp by rotating the second envelope 50, to compress at least one microswitches 31 of the power box 30 inside the second envelope 31. Therefore, the LED lamp turns off. Furthermore, the user may turn on the LED lamp by rotating the second envelope 50 in the opposite direction until all the microswitches 31 of the power box 30 protrude into the second envelope 50 (i.e., protruding into the first through holes 52) and are therefore uncompressed.

While the disclosure has been described by way of example and in terms of exemplary embodiment, it is to be understood that the disclosure is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An LED lamp, comprising: a tube-shaped first envelope, a cover arranged at one of two opposite ends of the first envelope, an LED module received in the first envelope and a power box arranged at the other one of the two opposite ends of the first envelope, wherein a tube-shaped second envelope has a color differing with a color of the first envelope, the second envelope is slideably mounted to the first envelope, a plurality of microswitches is arranged at a periphery of the power box; wherein when all of the microswitches protrude into the second envelope and is at an uncompressed status, the LED lamp turns on and light generated by the LED module radiates through the first envelope and then the second envelope to a surrounding environment, and wherein when at least one of the microswitches is compressed inside the second envelope, the LED lamp turns off.

2. The LED lamp of claim 1, wherein a first protruding strip extends from the first envelope, a slide is arranged at the second envelope, and the first protruding strip is slideable along the slide.

3. The LED lamp of claim 2, wherein the slide is defined at an inside surface of the second envelope.

4. The LED lamp of claim 3, wherein a second protruding strip extends from the inside surface of the second envelope, and a slot defined in an outside of the second protruding strip forms the slide.

5. The LED lamp of claim 1, wherein the microswitches are uniformly arranged at the periphery of the power box.

6. The LED lamp of claim 1, wherein a quantity of the microswitches is four.

7. The LED lamp of claim 1, wherein first through holes are defined in a bottom of the second envelope, and the microswitches protrude into the first through holes when the microswitches are at the uncompressed status.

8. The LED lamp of claim 1, wherein second through holes defined at a top of the second envelope, some of the microswitches are in the second through holes when the second envelope is slid relative to the first sleeve to an extremity position to expose the first sleeve.

9. The LED lamp of claim 1, wherein a master switch is at a bottom surface of the power box, and LED lamp turns off when the master switch is turned on irrespective of the status of the microswitches.
